(19) United States
(12) Patent Application Publication
(10) Pub. No.: US 2023/0196112 A1
(43) Pub. Date: Jun. 22, 2023

(54) META INPUT METHOD AND SYSTEM AND USER-CENTERED INFERENCE METHOD AND SYSTEM VIA META INPUT FOR RECYCLING OF PRETRAINED DEEP LEARNING MODEL

(71) Applicant: Korea Advanced Institute of Science and Technology, Daejeon (KR)

(72) Inventors: Yongman RO, Daejeon (KR); Youngjoon YU, Daejeon (KR); Minsu KIM, Daejeon (KR)

(73) Assignee: Korea Advanced Institute of Science and Technology, Daejeon (KR)

(21) Appl. No.: 18/066,637

(22) Filed: Dec. 15, 2022

(30) Foreign Application Priority Data
Dec. 16, 2021 (KR) 10-2021-0180193
Feb. 17, 2022 (KR) 10-2022-0020921
Oct. 7, 2022 (KR) 10-2022-0128314

(51) Int. Cl. G06N 3/084; G06N 5/04

(52) U.S. Cl. CPC G06N 3/084; G06N 5/04

(57) ABSTRACT

A meta input method and system and a user-centered inference method and system via a meta input for recycling of a pretrained deep learning model are provided. The meta input method for the recycling of the pretrained deep learning model performed by a computer device includes optimizing a meta input by considering a relation between input data and output prediction of the pretrained deep learning model and adding the optimized meta input to testing data in a user environment to transform distribution of the testing data into distribution of training data used to build the deep learning model.

### CROSS-REFERENCE TO RELATED APPLICATIONS

A claim for priority under 35 U.S.C. § 119 is made to Korean Patent Application No. 10-2021-0180193 filed on Dec. 16, 2021, Korean Patent Application No. 10-2022-0020921 filed on Feb. 17, 2022 and Korean Patent Application No. 10-2022-0128314 filed on Oct. 7, 2022, in the Korean Intellectual Property Office, the entire contents of which are hereby incorporated by reference.

### BACKGROUND

Embodiments of the inventive concept described herein relate to a meta input method and system and a user-centered inference method and system via a meta input for recycling of a pretrained deep learning model, and more particularly, relate to a method and a system for keeping inference performance high using new testing data without re-training the pretrained deep learning model.

Today, we live in an era of rapidly changing technological developments that may affect not only individual lives, but also society as a whole. With the development of these technologies, deep learning models learned with vast amounts of training data based on graphic processing unit (GPU)-based computing resources have been used for user-centered inference applications such as Internet of things (IoT) equipment or edge-devices. The deep learning models have excellent inference performance when the trained data is similar to data to be used by a user and are useful for object detection, recognition, and anomaly detection in the fields of autonomous driving, medical diagnosis, security, and automation. However, when the user input data is different from the trained data when applying the trained deep learning model to a user-centered application field, model inference performance is significantly degraded. Since most of the training data and the user's environment are actually different from each other, the deep learning model should be re-trained over a long time for performance on the testing data of a user. Since the testing data of the user changes depending on whether the user is in any environment and how he or she uses it, it is greatly difficult to apply the deep learning model trained with the training data that is different from the testing data to suit the actual user environment in terms of performance.

Such an existing deep learning model should be trained using vast amounts of data, training is required for a long time until the model is completed. The deep learning model trained in this way may obtain expected performance when the input data is similar to the training data upon inference, but, when the environment changes and the input data differs from the training data, the performance of the model deteriorates. The fundamental problems of such data-based deep learning include a catastrophic forgetting environment upon re-training, the problem of adding a new class, and the problem of data with different environmental changes.

### SUMMARY

Embodiments of the inventive concept are to generate a meta input suitable for the user environment in exploiting the pretrained deep learning model upon user-centered inference and utilize the meta input together with input data to maintain performance upon inference in the user environment even without re-training of the deep learning model.

However, technical problems to be addressed by the present embodiments is not limited to the problem, and may be expanded in various manners from a range which does not deviate from the technical spirit and scope of the present embodiments.

According to an exemplary embodiment, a meta input method for recycling of a pretrained deep learning model performed by a computer device may include optimizing a meta input by considering a relation between input data and output prediction of the pretrained deep learning model and adding the optimized meta input to testing data in a user environment to transform distribution of the testing data into distribution of training data used to build the deep learning model.

The optimizing of the meta input may include optimizing the meta input using a gradient-based training algorithm through backpropagation.

The adding of the optimized meta input to the testing data may include shifting or aligning the distribution of the testing data in the user environment to suit the distribution of the training data by adding the optimized meta input to the testing data.

The adding of the optimized meta input to the testing data may include matching the distribution of the testing data in the user environment to the distribution of the training data through the optimized meta input, such that knowledge of a pretrained black box deep neural network (DNN) already learned is able to be utilized even under an environment different from training.

The meta input method may further include generating the meta input in the distribution of the testing data in the user environment, when there is the pretrained deep learning model, before optimizing the meta input.

The generating of the meta input may include generating the meta input through ground truth of a sample of the testing data in the user environment.

The generating of the meta input may include sampling the testing data in the user environment and generating the meta input using the deep learning model and the sampled testing data in the user environment.

The meta input method may further include inputting and inferring an input, obtained by adding the optimized meta input to the testing data in the user environment, to the deep learning model.

According to an exemplary embodiment, a meta input system for recycling of a pretrained deep learning model may include a meta input optimization unit that optimizes a meta input by considering a relation between input data and output prediction of the pretrained deep learning model and a meta input addition unit that adds the optimized meta input to testing data in a user environment to transform distribution of the testing data into distribution of training data used to build the deep learning model.

The meta input optimization unit may optimize the meta input using a gradient-based training algorithm through backpropagation.

The meta input addition unit may shift or align the distribution of the testing data in the user environment to suit the distribution of the training data by adding the optimized meta input to the testing data.

The meta input addition unit may match the distribution of the testing data in the user environment to the distribution of the training data through the optimized meta input, such that knowledge of a pretrained black box deep neural network (DNN) already learned is able to be utilized even under an environment different from training.

The meta input system may further include a meta input generator that generates the meta input in the distribution of the testing data in the user environment, when there is the pretrained deep learning model, before optimizing the meta input.

The meta input generator may generate the meta input through ground truth of a sample of the testing data in the user environment.

The meta input generator may sample the testing data in the user environment and may generate the meta input using the deep learning model and the sampled testing data in the user environment.

An input obtained by adding the optimized meta input to the testing data in the user environment may be input to the deep learning model to be inferred.

According to an exemplary embodiment, a user-centered inference method for recycling of a pretrained deep learning model performed by a computer device may include generating a meta input in distribution of testing data in a user environment, when there is the pretrained deep learning model and inputting and inferring an input obtained by adding the optimized meta input to the testing data in the user environment, to the deep learning model. The generating of the meta input may include optimizing the meta input by considering a relation between input data and output prediction of the pretrained deep learning model and adding the optimized meta input to the testing data in the user environment to transform the distribution of the testing data into distribution of training data used to build the deep learning model.

The optimizing of the meta input may include optimizing the meta input using a gradient-based training algorithm through backpropagation.

The adding of the optimized meta input to the testing data may include shifting or aligning the distribution of the testing data in the user environment to suit the distribution of the training data by adding the optimized meta input to the testing data.

The adding of the optimized meta input to the testing data may include matching the distribution of the testing data in the user environment to the distribution of the training data through the optimized meta input, such that knowledge a pretrained black box deep neural network (DNN) already learned is able to be utilized even under an environment different from training.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIGS. 1A, 1i, and 1C are drawings for describing examples of exploiting a proposed meta input in an object detection task according to an embodiment;

FIG. 2 is a drawing for describing optimization of a meta input in an inference step according to an embodiment;

FIG. 3 is a drawing for describing inference using an optimized meta input according to an embodiment;

FIG. 4 is a flowchart illustrating a meta input method for recycling of a pretrained deep learning model according to an embodiment;

FIG. 5 is a block diagram illustrating a meta input system for recycling of a pretrained deep learning model according to an embodiment;

FIG. 6 is a flowchart illustrating a user-centered inference method via a meta input for recycling of a pretrained deep learning model according to an embodiment;

FIG. 7 is a block diagram illustrating a user-centered inference system via a user input for recycling of a pretrained deep learning model according to an embodiment;

FIG. 8 is a drawing for describing a process of generating a meta input according to an embodiment;

FIGS. 9A and 9B are drawings for describing a process of inferring a meta input according to an embodiment;

FIGS. 10A, 10B, 10C and FIGS. 11A and 11B are drawings for comparing and describing performance of a deep learning model according to a meta input according to an embodiment;

FIGS. 12A, 12B, and 12C, FIGS. 13A, 13B, and 13C, and FIGS. 14A, 14B, and 14C are drawings illustrating examples of a meta input when input data is an image according to an embodiment;

FIGS. 15A, 15B, and 15C, FIGS. 16A, 16B, and 16C, and FIGS. 17A, 17B, and 17C are drawings illustrating examples of a meta input when input data is a voice according to an embodiment;

FIGS. 18A, 18B, and 18C, FIGS. 19A, 19B, and 19C, and FIGS. 20A, 20B, and 20C are drawings illustrating examples of a meta input when input data is a video according to an embodiment;

FIGS. 21, 22, and 23 are drawings illustrating experimental results inferred with testing images and meta inputs according to an embodiment; and

FIG. 24 is a drawing illustrating a configuration of a user-centered inference system via a meta input according to an embodiment.

### DETAILED DESCRIPTION

Hereinafter, embodiments of the inventive concept will be described with reference to accompanying drawings. However, embodiments to be described may be modified in the different forms, and the scope and spirit of the inventive concept is not limited by the embodiments to be described below. In addition, various embodiments are provided to describe this disclosure more fully to those skilled in the art. For a clear description, forms, sizes, and the like of elements may be exaggerated in a drawing.

Recently, as a deep neural network (DNN) has been developed, high accuracy has been shown in various fields such as image classification and object detection. Such a deep learning model is learned using vast amounts of data, training is required for a long time to complete the deep learning model. Furthermore, the environment should be similar to training data to achieve expected performance. When the environment is changed, the performance of the model is degraded. Since most training data and an environment inferred by a user are actually different from each other, the deep learning model should be re-trained for performance in inference data of the user.

Embodiments below propose the generation of a meta input signal which serves to help maintain existing performance even in an inference environment in which the deep learning model which receives new testing data is changed. As a result, the embodiments are to keep inference performance high using the new testing data without re-training when testing the pretrained deep learning model.

Embodiments provide a method for generating a meta input and inferring the meta input from the user's point of view to recycle the pretrained deep learning model, thus providing a method where the DNN is able to maintain its performance although a training environment and a user environment are different from each other. The deep learning model currently have excellent inference performance and are useful for object detection, recognition, and anomaly detection in the fields of autonomous driving, medical diagnosis, security, and automation. However, the deep learning model is completed with training of vast amounts of data, and it takes a lot of time to perform training to obtain one model. Furthermore, when user input data and training data are greatly different from each other when applying the trained deep learning model to an application field, model inference performance is degraded. The technology for generating the meta input signal proposed in the present embodiment uses pretrained model parameters as they are, but may achieve high performance even on testing data different from training data.

A meta input method and system and a user-centered inference method and system via a meta input for recycling of pretrained deep learning model are the gist of keeping inference performance high using new testing data without the re-training of the pretrained deep learning model.

Embodiments may generate a meta input and may use the meta input together with input data for user edge inference. At this time, the meta input is generated to suit an inference environment of the user from the point of view of using the pretrained deep learning model when the user performs edge inference in response to the purpose of a task. In other words, embodiments may generate a meta input using the distribution of user utilization data and may perform inference of maximum performance using the meta input and the pretrained deep learning model.

Thus, embodiments propose a new artificial intelligence utilization scheme capable of using the pretrained model as it is to suit a user-centered environment, when exploiting the pretrained model for user-centered inference. Particularly, embodiments are to show the usefulness of the proposed method with a problem which causes an unintended output or causes errors in a device to reduce the reliability and convenience of the deep learning model, as noise occurs due to various causes when deep learning model used for image processing are generally utilized as edge-devices in a user-centered environment. To this end, unlike training data, embodiments propose an algorithm capable of maintaining the performance of the deep learning model without re-training even in a user-centered test environment in which noise is mixed. The purpose of the present embodiment is to use the deep learning model without the re-training of the deep learning model when inferring the deep learning model requiring training for a long time using vast amounts of data in the user-centered environment. Embodiments generate a meta input and use the meta input together with input data, upon user-centered inference. As a result, although data having a characteristic fully different upon training is input to the pretrained model, as the user exploits the data together with the meta input, embodiments may maintain the performance of the deep learning model. This is an idea that separates the learning model from user inference in the user-centered inference and is referred to as a new method of presenting processing upon inference in the utilization of a data-based deep learning model.

Hereinafter, a description will be given of a meta input method and system for recycling of a pretrained deep learning model. Herein, a meta input method and system in a black box DNN will be described as an example.

Embodiments propose a novel approach that allows end-users to exploit pretrained black box DNNs in their own testing environment through input-level transformation of the DNNs. In detail, embodiments propose an additional input called a meta input for transforming testing data designed to reduce the environment discrepancy between training and testing. Such discrepancy is widely known that it causes performance degradation of the trained black box DNNs, resulting in the lack of practicality of the DNNs in a real-world environment. The proposed approach considers the pretrained model as a black box, unlike an existing adaptation method which requires finetuning of the model. Thus, the proposed meta input may be obtained without knowing the network architecture and modifying its weight parameters. To this end, embodiments optimize the meta input by considering the relation between the input data and output prediction of the model. Then, the optimized meta input is added to testing data in order to shift and align the distribution of the testing data to suit the distribution of originally used training data. As a result, end-users may exploit black box models in their own testing environment different from the training environment. Embodiments verify the practicality and effectiveness of the meta input proposed to improve the performance of the black box DNNs in various application fields including image classification, object detection, and visual speech recognition.

Recently, as the deep learning has achieved a great development, deep neural networks (DNNs) well-trained on large databases have shown remarkable performances in various areas, such as computer vision, natural language processing, and speech processing. Nevertheless, there exists one significant problem in showing strong performance and utilizing DNNs in the real-world application. That is, there is the environment discrepancy. It is well known that the environment discrepancy results in the serious performance degradations of DNNs. Therefore, although users are provided with one of the most advanced models, they would fail to experience the powerfulness of DNNs in their own testing environment.

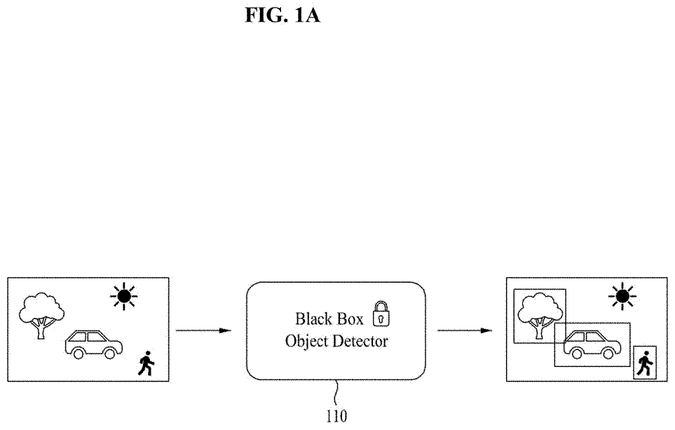

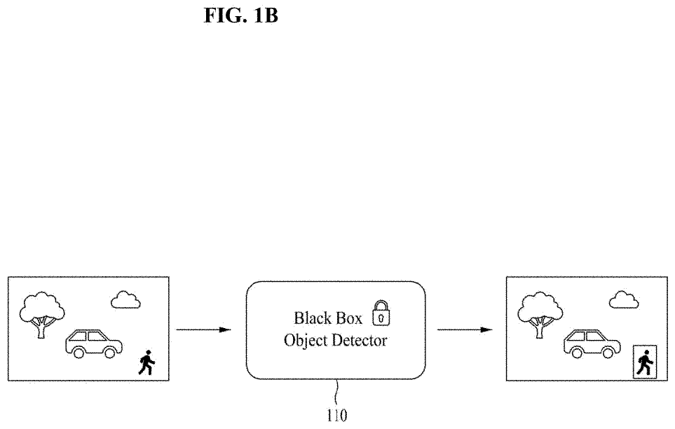

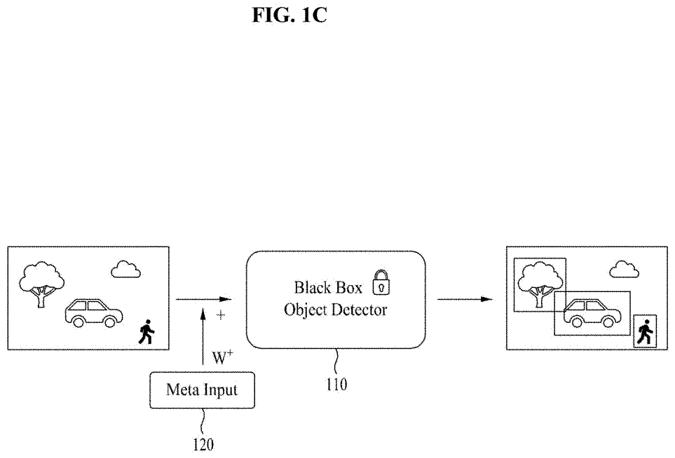

FIGS. 1A to 1C are drawings for describing examples of exploiting a proposed meta input in an object detection task according to an embodiment.

For example, as shown in FIG. 1A, a black box detector 110 which is trained in a clean weather condition may perform detection successfully in the same testing condition. However, as shown in FIG. 1B, when the user wants to apply such a model under adverse weather condition, the black box detector 110 may fail to properly conduct the object detection. In this case, for now, users are recommended not to exploit the models in an environment that is consistent with the training environment.

One possible approach to alleviate such a problem is domain adaptation (DA) which aims to reduce the domain gap between the source domain and the target domain by learning the domain invariant representations. However, such DA methods are usually required to know the internal architecture (i.e., the white-box) of the network and have an access to both of a source database and a target database simultaneously for training. It is time-consuming and difficult for end-users to understand the network architecture.

The present embodiment focuses on how to make end-users enjoy the performances of well-trained DNN models under the shifted data distribution at the inference stage (i.e., the end point). Thus, the present embodiment aims to provide a framework which allows end-users to adapt the model into their testing environment when treating the model as a black box (i.e., without any knowledge of model architecture or finetuning the model). Motivated by the recent success in the input-level transformation of DNNs to convert the originally learned task to another task, instead of modifying the weight parameters of the well-trained models, embodiments propose to use an additional input, called meta input, to match the distribution of testing data with that of training data. Specifically, embodiments suppose that an end-user wants to adopt a black box model under different testing environment with a few labeled/unlabeled testing data only, while the user may not have an access to the training data which is used to train the model. Then, the proposed framework optimizes the meta input to transform the testing input data to be aligned with the training data.

As illustrated in FIG. 1C, the meta input may be embedded into the testing data, so that the black box object detector 110 may properly operate even under adverse weather condition. As such, the black box object detector 110 may perform detection properly even for the testing data captured in the adverse weather condition by means of a meta input 120. The meta input 120 may be to transform the distribution of the testing data into the distribution of the training data. Herein, the training data may be used for training of the black box object detector 110.

With the proposed meta input 120, the learned knowledge of pretrained models may be extended to diverse testing environments without knowing the network architecture and modifying its weight parameters. Therefore, end-users may experience improved performance with off-the-shelf DNNs on their own testing data by managing the meta input 120 corresponding to the environment. The meta input 120 may be optimized simply with any gradient-based training algorithm through backpropagation. Embodiments show the effectiveness and real-world availability of the proposed method through the extensive experiments in the three tasks, image classification, object detection, and visual speech recognition.

The contributions of the present embodiments may be summarized as follows: In black box settings where users only have access to the inputs and the output predictions of the model, the proposed meta input may match the distribution of testing data with that of training data. Therefore, the knowledge the black box DNN already learned may be utilized even under environments different from the training environments. Furthermore, different from the existing DA methods which modify the weight parameter of the network and utilize source domain data and target domain data at the same time, the proposed meta input does not require finetuning of the model and only needs a small number of testing data. Furthermore, the practicality of the proposed method is verified extensively from a basic image classification task to object detection and visual speech recognition tasks.

DNNs have been widely adopted to extract the generalized feature representation of the data. To train such generalized DNNs, it assumes that both training data and testing data are originated from the same distribution and share some similar joint probability distribution. In the real-world scenario, however, this constraint is easily violated, because a training set and a testing set may be drawn from different features and distributions. To tackle the aforementioned problems, existing researchers have devoted their efforts on a research field called DA. DA is a technique that enables DNNs learned with sufficient label and data size (i.e., source domain) to perform and generalize well on data sampled from different distributions (i.e., target domain). DA may be categorized into discrepancy-based methods, adversarial-based methods, and reconstruction-based methods. Most of the existing works of DA focus on enhancing the model performance by adopting an additional cost of the model architecture modification or re-training. Moreover, they usually need both source domain data and target domain data simultaneously.

Different from DA, embodiments propose a novel method called meta input which does not require knowing about the model architecture and finetuning of the model. The proposed meta input is an additional input for transforming the testing input of the DNN. Therefore, by processing the DNN pretrained for the source domain data using the black box, the meta input may improve the performances of the model by transforming the testing input distribution into the training data used to build a black box model.

Recently, input transformation methods attract large attention with its potential to interact with a trained model without modification of its weight parameters. For example, DNNs trained to classify classes of samples from a source task (e.g., ImageNet classification) may be reprogrammed to classify hand-written digits target task (e.g., digits classification). To this end, a mapping function between the class labels of the source task and the class labels of the target task should be organized in advance. Once such a class mapping process is finished, the frame-shaped adversarial perturbation is applied surrounding the input image to perform the target task. Embodiments try to provide a framework using input transformation, so that end-users may work on with an off-the-shelf DNN developed for a certain task without considering the gap between a training environment and a testing environment. Different from the aforementioned input transformation works, embodiments do not consider the different tasks scenario but focus on how to use the black box DNNs in end-users' environments that are usually distinct from the development environment.

Embodiments consider that an end-user has an access to a pretrained DNN which may perform a specific task (e.g., image classification, etc.). The given neural network f is pretrained on the training data, called source domain data, [symbol] ={xₛⁱ, yₛⁱ}ᵢ₌₁^{N}^{ₛ}∈{ [symbol] ₛ, [symbol] ₛ}, consisting of Ns samples, as follows,

$$\begin{matrix}[ Equation 1 ] & \\ {⊖}^{*} = {argmin}_{⊖} {𝔼}_{i} [ ℒ ( {f}_{⊖} ( {x}_{s}^{i} ) , {y}_{s}^{i} ) ] , & ( 1 )\end{matrix}$$

where xₛⁱ and yₛⁱ are the i-th source domain sample and its corresponding label, respectively, [symbol] (⋅) represents the objective function defined for the task, and Θ is learnable parameters of the neural network.

Then, the pretrained model may be regarded as a mapping function ƒ_{Θ*}: [symbol] ₛ→ [symbol] ₛ performing predictions on the source domain data properly, which is parameterized by Θ*.

It is assumed that an end-user wants to apply the model on their own testing data, called target domain data, [symbol] ={{x_{l,t}ⁱ, y_{l,t}ⁱ}ᵢ₌₁^{N}^{_{l,t}}, {x_{u,t}^{j}}ⱼ₌₁^{N}^{_{u,t}}}, consisting of labeled samples N_{l,t} and unlabeled samples N_{u,t}, where {x_{l,t}, x_{u,t}}∈ [symbol] ₜ and y_{l,t}∈ [symbol] ₜ. The labeled samples are typically very few compared to the source domain data. That is, 0≤N_{l,t}<<Nₛ. Usually, target domain may be changed dynamically depending on which environment a user wants to apply, so that the distribution of target domain data may differ from that of source domain data. In this case, the pretrained model would not make predictions properly on the data (e.g ƒ_{Θ*}: [symbol] ₜ→ [symbol] ₜ) that a user wants to test because of the mismatch of training and testing environments.

To deal with it, the present embodiments present a meta input W which is an additional input that will be applied into the testing data to make the pretrained model perform predictions properly on target domain data as well. Therefore, embodiments aim to construct a mapping function ƒ_{Θ*}: ( [symbol] ₜ+W)→ [symbol] ₜ without modifying the originally learned weight parameters Θ* by only adding the proposed meta input W to the testing data sampled from Xₜ and processing the model using the black box.

Hereinafter, a description will be given of the outline of the proposed meta input when the target testing data has a distribution different from the source train data used to instruct the black box network.

The meta input be optimized in the inference step by examining input and output relationships. Since the trained model is treated as a black box, the weight parameters are not modified during optimization. After the optimization, the meta input is added to a testing sample the user wants to work with. Adding the meta input aligns the distribution of the testing data with the trained model and yields robust performance.

FIG. 2 is a drawing for describing optimization of a meta input in an inference step according to an embodiment.

Referring to FIG. 2, optimization flow of the meta input is illustrated in the inference step. The proposed meta input W 220 is learnable and universal, so that it may be embedded into every target domain data 210 once after it is optimized. The meta input 220 may be optimized by investigating the relationships between the target inputs covered by the meta input 220 and the model prediction scores. Then, the optimized meta input may convert the distribution of target domain data into that of training source domain data, and it makes the trained model 230 perform properly on target domain data 210 as well.

For the better understanding, hereinafter, embodiments suppose the data type as the image. When the target input image comes in, a meta input [symbol] ∈ [symbol] ^{H×W×C} occupies the entire image, having the same size as the input image, where H, W, and C are the dimensions of height, width, and channel, respectively.

To transform the target domain images into the source domain in the latent space, embodiments apply input-level transformation by adding the meta input W to the target domain images as follows, \tilde{x}ₜ=xₜ+ [symbol] , where \tilde{x}ₜ is the transformed image. The optimal meta input W* may be acquired by solving the following optimization problem,

$$\begin{matrix}[ Equation 2 ] & \\ {𝒲}^{*} = {argmin}_{𝒲} {𝔼}_{i} [ ℒ ( {f}_{{⊖}^{*}} ( {\tilde{x}}_{l , t}^{i} ) , {y}_{l , t}^{i} ) ] , & ( 2 )\end{matrix}$$

where it may be solved using gradient-based training algorithms.

By minimizing the task loss [symbol] (⋅) without updating the trained model parameter Θ*, the [symbol] meta input may be optimized, so that the target domain images may have a similar distribution to the source domain data in the latent space.

FIG. 3 is a drawing for describing inference using an optimized meta input according to an embodiment.

The optimized meta input W* 320 may be applied into the target input image via element-wise addition, as shown in FIG. 3. Therefore, with the optimized meta input 320, the given pretrained model ƒ_{Θ*} 330 may robustly operate on the testing data 310 with the following formula, [symbol] =ƒ_{Θ*}(x_{u,t}+ [symbol] *). Here, [symbol] is the prediction result for the unlabeled target data x_{u,t} that a user wants to test. Even if embodiments assume that the labeled target domain data x_{l,t} is available (i.e., 0<N_{l,t}), the existing unsupervised methods (non-patent document 1) may be adopted for solving the optimization problem, when there is no labeled target domain data (i.e., N_{l,t}=0). For example, embodiments may employ the self-training methods (non-patent document 1) to firstly perform pseudo labeling on the unlabeled samples using the pretrained model 330 and to use the pseudo labels for training. The model confidence-based pseudo labeling may be written as follows,

[Equation 3]

[symbol]

_{u,t}=argmax ƒ_{Θ*}(x_{u,t}), if α<p( [symbol] _{u,t}|x_{u,t})<β (3)

where α and β determine the model confidence range for using predictions as real labels.

With the obtained pseudo labels [symbol] _{u,t}, embodiments may easily solve the optimization in Equation 2 above.

The optimized meta input W* 320 may transform the testing input x_{u,t} and may transmit the testing input to the source domain of the latent space. Therefore, the trained model 330 may properly process the domain shift samples and may provide end-users with the accurate prediction 340.

FIG. 4 is a flowchart illustrating a meta input method for recycling of a pretrained deep learning model according to an embodiment.

Referring to FIG. 4, the meta input method for the recycling of the pretrained deep learning model performed by a computer device according to an embodiment may include optimizing (S110) a meta input by considering a relation between input data and output prediction of the pretrained deep learning model and adding (S120) the optimized meta input to testing data in a user environment to transform the distribution of the testing data into that of training data used to build the deep learning model.

According an embodiment, the meta input method for the recycling of the pretrained deep learning model may further include generating the meta input in the distribution of the testing data in the user environment, when there is the pretrained deep learning model, before optimizing the meta input.

Hereinafter, a description will be given in detail of the meta input method for the recycling of the pretrained deep learning model according to an embodiment.

A meta input system for recycling of a pretrained deep learning model according to an embodiment will be described as an example in the meta input method for the recycling of the pretrained deep learning model according to an embodiment.

FIG. 5 is a block diagram illustrating a meta input system for recycling of a pretrained deep learning model according to an embodiment.

Referring to FIG. 5, a meta input system 500 for recycling of a pretrained deep learning model according to an embodiment may be implemented, including a meta input optimization unit 510 and a meta input addition unit 520. The meta input system 500 for the recycling of the pretrained deep learning model according to an embodiment may further include a meta input generator.

In operation S110, the meta input optimization unit 510 may optimize a meta input by considering a relation between input data and output prediction of the pretrained deep learning model. The meta input optimization unit 510 may optimize the meta input using a gradient-based training algorithm through backpropagation.

In operation S120, the meta input addition unit 520 may add testing data in a user environment to the optimized meta input to transform the distribution of the testing data into that of training data used to build the deep learning model. In detail, the meta input addition unit 520 may shift or align the distribution of the testing data in the user environment to suit the distribution of the training data by adding the optimized meta input to the testing data. As such, the meta input addition unit 520 may match the distribution of the testing data in the user environment to that of the training data through the optimized meta input, such that the knowledge the pretrained DNN models already learned may be utilized even under an environment different from training.

Embodiments may input and infer the input, obtained by adding the optimized meta input to the testing data in the user environment, to the deep learning model.

According an embodiment, the meta input system 500 may further include a meta input generator for generating the meta input in the distribution of the testing data in the user environment, when there is the pretrained deep learning model, before optimizing the meta input.

The meta input generator may generate the meta input through the ground truth of a sample of the testing data in the user environment. The meta input generator may sample the testing data in the user environment and may generate the meta input using the deep learning model and the sampled testing data in the user environment. Meanwhile, the meta input generator may be included in a generator described below with reference to FIG. 7 or may include the generator.

As such, embodiments present a technology for adding the meta input to testing input content to keep inference performance high with new testing data without re-training when testing the pretrained deep learning model.

Hereinafter, a description will be given of a user-centered inference method and system via a meta input for recycling of a pretrained deep learning model.

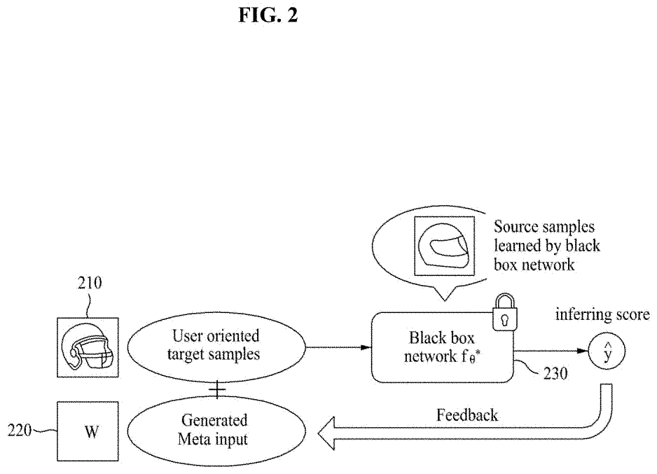

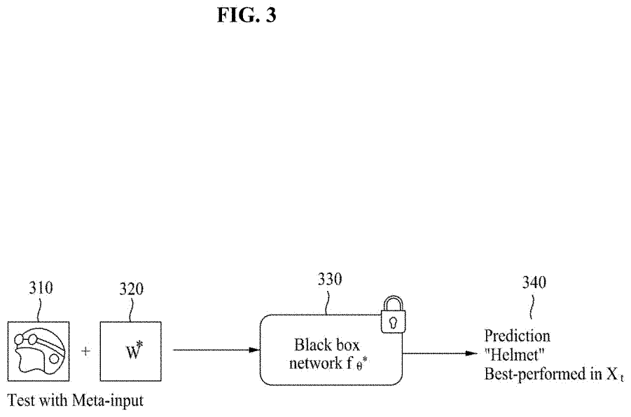

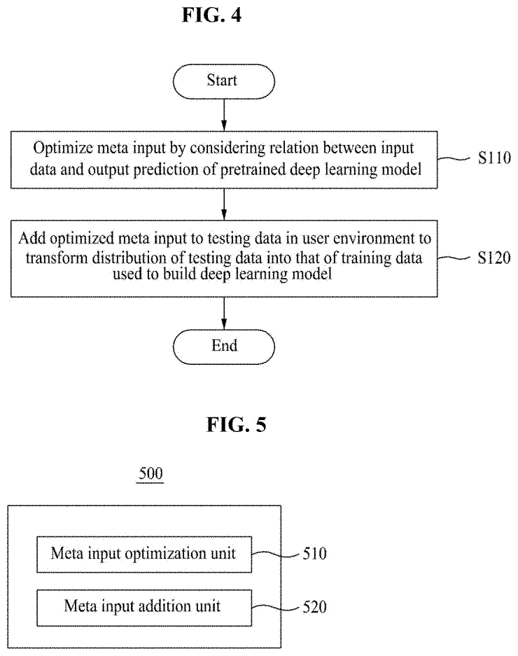

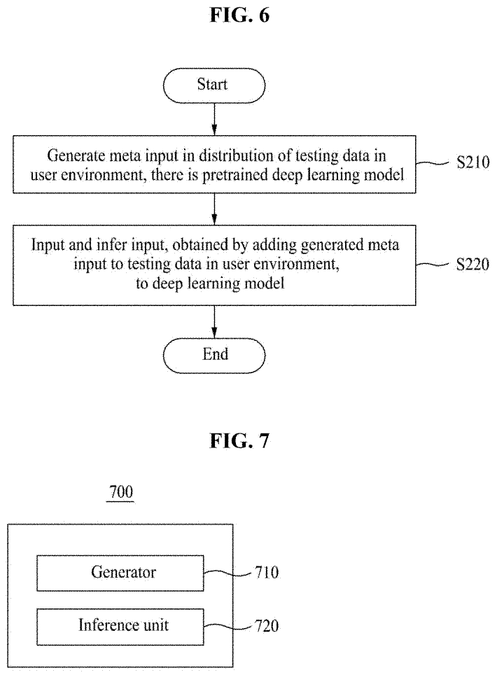

FIG. 6 is a flowchart illustrating a user-centered inference method via a meta input for recycling of a pretrained deep learning model according to an embodiment.

Referring to FIG. 6, the user-centered inference method via the meta input for the recycling of the pretrained deep learning model performed by a computer device according to an embodiment may be implemented, including generating (S210) a meta input in the distribution of testing data in a user environment, when there is the pretrained deep learning model, and inputting and inferring (S220) an input, obtained by adding the generated meta input to the testing data in the user environment, to the deep learning model.

Herein, the generating of the meta input may include optimizing the meta input by considering a relation between input data and output prediction of the pretrained deep learning model and adding the optimized meta input to the testing data in the user environment to transform the distribution of the testing data into the distribution of training data used to build the deep learning model. Meanwhile, the optimizing of the meta input may include operation S110 described with reference to FIGS. 4 and 5 or may be included in operation S110. The adding of the optimized meta input to the testing data may include operation S120 described with reference to FIGS. 4 and 5 or may be included in operation S120.

A user-centered inference system via a meta input for recycling of a pretrained deep learning model according to an embodiment will be described as an example in the user-centered inference method for the recycling of the pretrained deep learning model according to an embodiment.

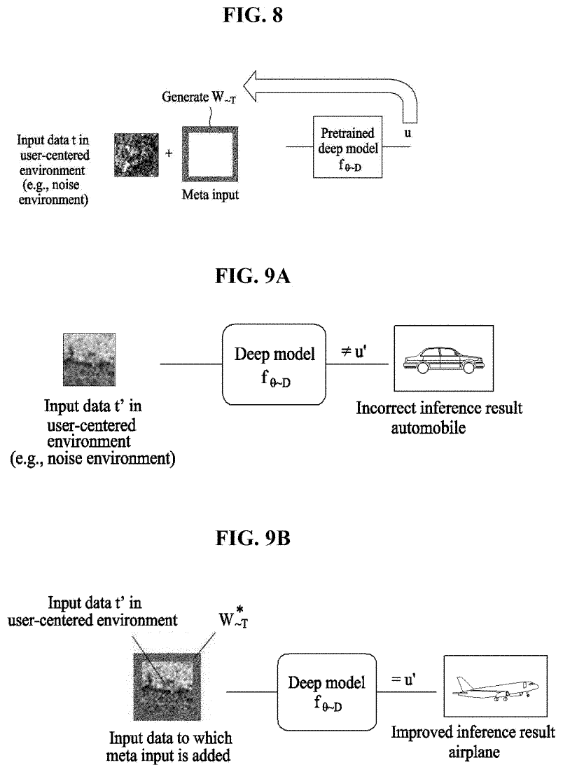

FIG. 7 is a block diagram illustrating a user-centered inference system via a user input for recycling of a pretrained deep learning model according to an embodiment. Furthermore, FIG. 8 is a drawing for describing a process of generating a meta input according to an embodiment. FIGS. 9A and 9B are drawings for describing a process of inferring a meta input according to an embodiment.

Referring to FIG. 7, a user-centered inference system 700 for recycling of a pretrained deep learning model according to an embodiment may include a generator 710 and an inference unit 720.

In operation S210, the generator 710 may generate a meta input in the distribution of testing data in a user environment, when there is a pretrained deep learning model.

Referring to FIG. 8, operation S210 may be to optimize training data {x}∈D) and generate a meta input W in the distribution T of testing data in a user-centered environment, when there is a pretrained deep learning model ƒ_{θ}_{_{˜D}}. At this time, operation S210 may be to generate a meta input W˜_{T} through ground truth U of a sample T of the testing data in the user-centered environment. Thus, operation S210 may be to sample the testing data in the user environment and generate the meta input using the pretrained deep learning model and the sampled testing data in the user environment.

At this time, the meta input may be represented as Equation 4 below.

$${W}_{∼ T} = {argmin}_{W} [ ℒ ( {f}_{{θ}_{∼ D}} ( {t}_{∼ T} + \hat{W} ) , {u}_{∼ U} ) ] \qquad [ Equation 4 ]$$

In the generation process in the present embodiment, the loss function like Equation 5 below is minimized for the meta input W˜_{T} to optimize the meta input W˜_{T}.

[symbol]

[ƒ_{θ}_{_{˜D}}(t+W_{˜T}),u_{˜U}] [Equation 5]

Operation S210 may be to achieve existing high performance upon interference, although the pretrained deep learning model is utilized as it is without re-training by adding the optimized meta input W*˜_{T} although any testing data is input within the testing data sample distribution T through the meta input W*˜_{T} generated in such an optimization scheme.

In operation S220, the inference unit 720 may input and infer an input, obtained by adding the generated meta input to the testing data (testing input data) in the user environment, to the pretrained deep learning model.

Referring to FIGS. 9A and 9B, as shown in FIG. 9A, in existing basic image classification models, when the input data in the user environment is a noise environment called T, which is completely different from training data D, incorrect misclassification occurs due to data characteristics different from the trained data, resulting in a serious decrease in performance. Existing methods known to address such problems generate new training data including user data to re-train the deep learning model ƒ_{θ}. This has a fundamental problem in which the training time increases and re-training itself is difficult because there are many cases where users using actual edge-devices do not know the deep network structure and training data.

Instead, as shown in FIG. 9B, when the meta input generated in operation S210 is utilized, the pretrained deep learning model may be exploited immediately. Operation S220 may be to add the optimized meta input W*˜_{T} to the testing data t′ in the user environment and may input an input, in which the testing data t′1 in the user environment and the optimized meta input W*˜_{T} are combined with each other, to the pretrained deep learning model. Then, it is possible to use the pretrained deep learning model while maintaining performance in the distribution of new input data while using the parameters of the existing model as they are by giving the correct answer u′ of the input t′ even with the pretrained deep learning model.

Therefore, the user-centered inference method via the meta input according to the present embodiment achieves high inference performance in training data different from testing data while using external signals as parameters of the pretrained deep learning model as they are. At this time, the external signal may play a role in helping the deep learning model receiving the new testing data to achieve the best performance.

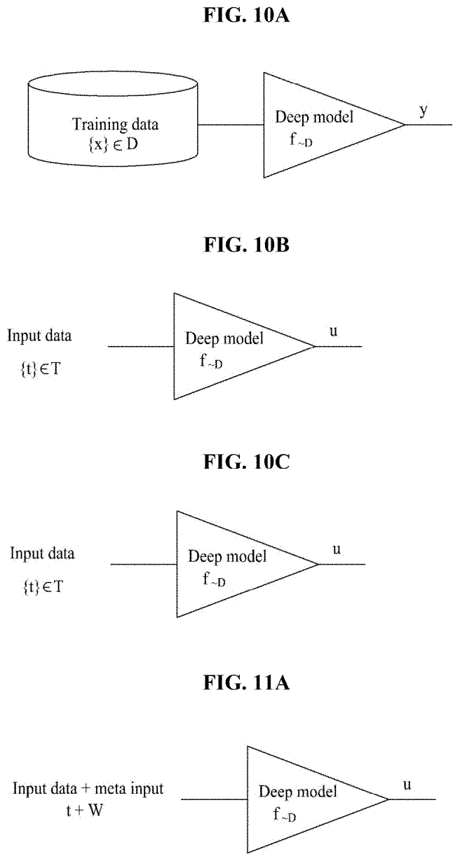

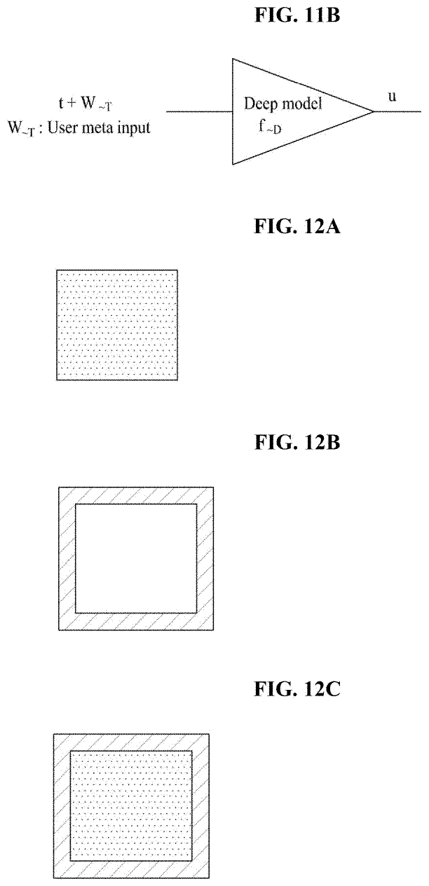

FIGS. 10A to 11B are drawings for comparing and describing performance of a deep learning model according to a meta input according to an embodiment. In detail, FIG. 10A is a drawing for describing training of a deep learning model. FIG. 10B is a drawing for describing inference of a deep learning model. FIG. 10C is a drawing for describing performance of a deep learning model, when input data is different from training data. Furthermore, FIG. 11A is a drawing for describing an example of inferring a deep learning model with input data to which a meta input is added. FIG. 11B is a drawing for describing a method for obtaining a meta input according to an embodiment.

Referring to FIG. 10A, the deep learning model may be learned to satisfy

$${min}_{f} L [ {f}_{∼ D} ( x ) , y ] .$$

This may be learned through an output (ground truth) of the deep learning model to an input x following the distribution of training data D, when there a deep learning model optimized for the training data D.

Referring to FIG. 10B, the performance of the deep learning model may be identified with testing data of a user. For an environment (˜T≠˜D) in which the distribution of the testing data and the distribution of the training data are different from each other, the testing data ({t}∉D) differs in data environment from the training data. Thus, as L [θ_{˜D}(t), u] increases, the deep learning model f_{˜D} may not give a correct answer of the input t. Since an existing method should generate new training data with T+D in such an environment to learn the deep learning model f to f˜_{(T+D)} again, a training time becomes long. Since there are actually many cases where the user is unable to know training data, it is difficult to perform re-training.

Referring to FIG. 10C, when the input data is different from the training data, it may be seen that deep learning performance becomes very low although testing data ({t}∉D) is input.

Referring to FIG. 11A, according to an embodiment, a deep learning model may be inferred with input data to which a meta input is added. When {t}+meta input is input to the deep learning model, as L[ƒ_{˜D}(t+m), u] decreases, the deep learning model f˜_{D} may give a correct answer u of the input t. Therefore, even without re-training of the deep learning model f, the existing model f˜_{D} may be utilized in new input data.

Referring to FIG. 11B, upon testing, a meta input W may be learned and generated in the distribution T of testing data in the user environment. Embodiments may generate a meta input suitable for the user and may generate a meta input W˜_{T} using the distribution T of user input data and ground truth U of T. At this time, the meta input may be represented as Equation 4 above. Therefore, although any input data is input within T, when the meta input W˜_{T} is added, inference of high performance is possible. Re-training of the deep learning model is not required due to this, and new input data t+W˜_{T} may be utilized by being input to the existing model f˜_{D}.

According to an embodiment, the user may know input distribution upon inference. Embodiments sample the input distribution T. Thus, embodiments may generate a meta input W˜T using T and the pretrained deep learning model. The amount of calculation for generating the meta input is less than the amount of calculation for re-training f˜_{(T+D)}. At this time, since the user knows the input data, the number of samplings for T may be small.

Therefore, the user-centered inference method via the meta input according to an embodiment may exploit an existing training model for inference even in a changed environment and may maintain and exploit performance in edge inference. Furthermore, since training data is utilized although an inference user does not know the training data, practicality increases.

The user-centered inference method via the meta input according to an embodiment may obtain a meta input suitable for input data matched to the inference environment. For example, when having a deep learning model trained with data obtained in a very good environment, as the user generates a meta input suitable for the changed user environment and inputs it together with the user input data, the pretrained deep learning model may achieve excellent performance despite the changed user environment. Therefore, embodiments may propose a groundbreaking technique for exploiting data-based deep learning models with an idea that separates the learning model from the user inference environment. This is optimized to exploit the model by generating the meta input suitable for the user environment even upon edge inference.

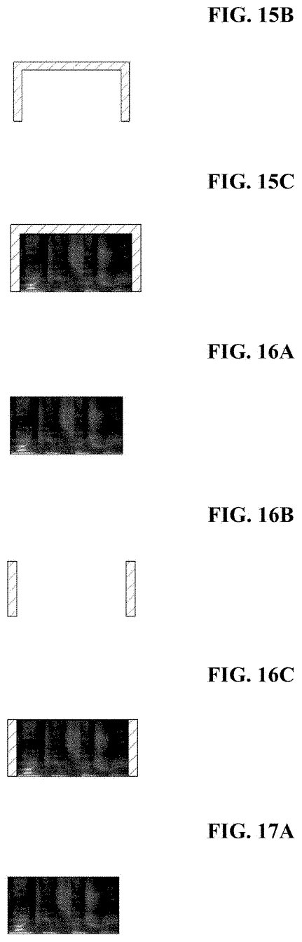

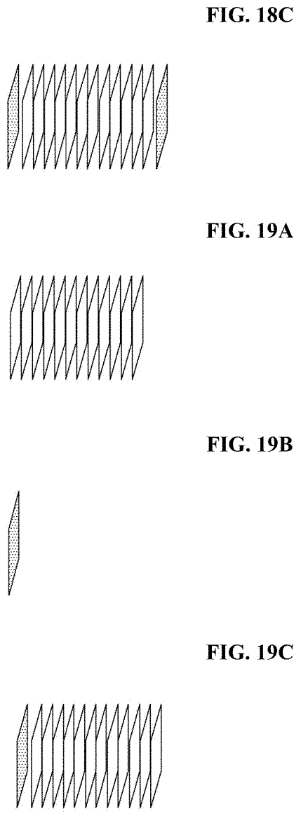

FIGS. 12A to 14C are drawings illustrating examples of a meta input when input data is an image. FIGS. 15A to 17C are drawings illustrating examples of a meta input when input data is a voice. FIGS. 18A to 20C are drawings illustrating examples of a meta input when input data is a video.

A meta input according to an embodiment may indicate an input in which the performance of a pretrained deep learning model is optimally achieved irrespective of input content, which may be an input for input content.

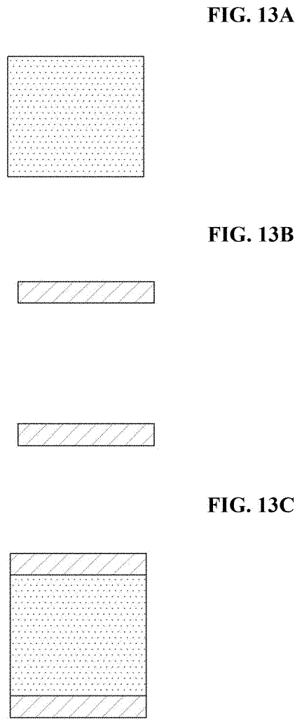

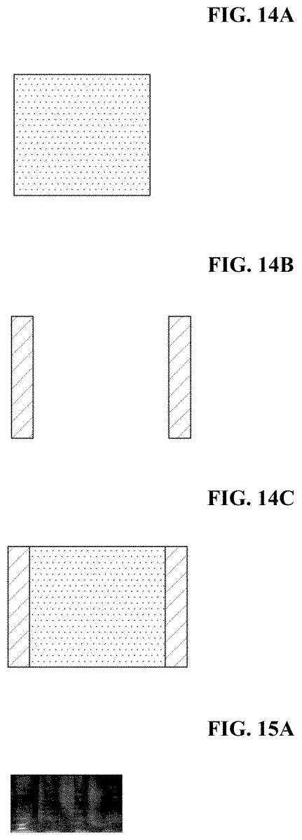

Referring to FIGS. 12A to 14C, FIG. 12A, FIG. 13A, and FIG. 14A illustrate input data t indicating an image, FIG. 12B, FIG. 13B, and FIG. 14B illustrate a meta input image W˜_{T}. FIG. 12C, FIG. 13C, and FIG. 14C illustrate new input data t+W˜_{T} in which an input image and a meta input are combined with each other.

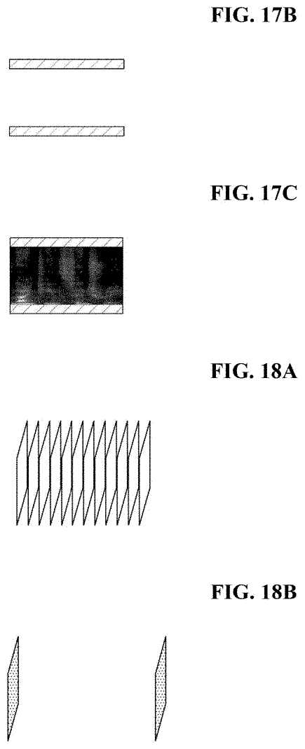

Referring to FIGS. 15A to 17C, FIG. 15A, FIG. 16A, and FIG. 17A illustrate input data t indicating an audio (or a voice). FIG. 15B, FIG. 16B, and FIG. 17B illustrate a meta input audio W˜_{T}. FIG. 15C, FIG. 16C, and FIG. 17C illustrate new input data t+W˜_{T} in which an input audio and a meta input are combined with each other. At this time, FIGS. 15A to 15C illustrate examples of a meta input for time and frequency. FIGS. 16A to 16C illustrate examples of a meta input for time. FIGS. 17A to 17C illustrate examples of a meta input for frequency.

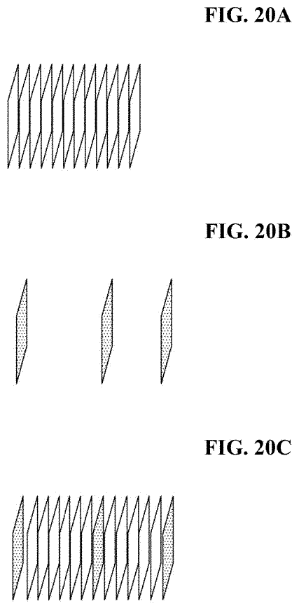

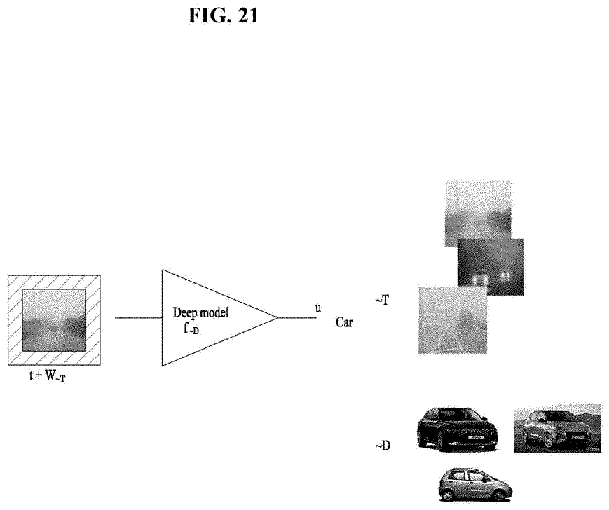

Referring to FIGS. 18A to 20C, FIG. 18A, FIG. 19A, and FIG. 20A illustrate input data t indicating a video. FIG. 18B, FIG. 19B, and FIG. 20B illustrate a meta input image W˜_{T}. FIG. 18C, FIG. 19C, and FIG. 20C illustrate new input data t+W˜_{T} in which an input video and a meta input are combined with each other. Herein, the meta input indicates time and frequency.

FIGS. 21 to 23 are drawings illustrating experimental results inferred with test images and meta inputs according to an embodiment.

Referring to FIG. 21, the result u of recognizing a car in a foggy environment through a deep learning model using input data t+W˜_{T} in which a testing image and a meta input for a rainy and cloudy day is illustrated. A deep learning model f˜_{D} is a model trained with a clear image D.

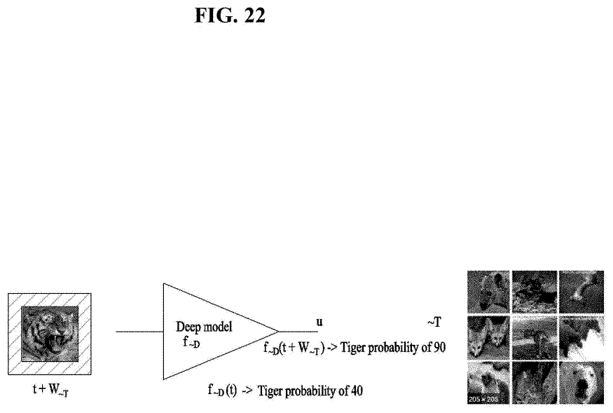

Referring to FIG. 22, the result u of recognizing a tiger with a high probability through a deep learning model using input data t+W˜_{T} in which a tiger recognition test image with low performance and a meta input are combined with each other in a task of recognizing a specific object is illustrated. A deep learning model f˜_{D} is a low layer model in which performance trained with a tiger image D decreases. Thus, it may be seen that the meta input plays a role in improving the performance with a basic model with low performance. The embodiments may obtain inference results with high performance even with a low layer model with the meta input.

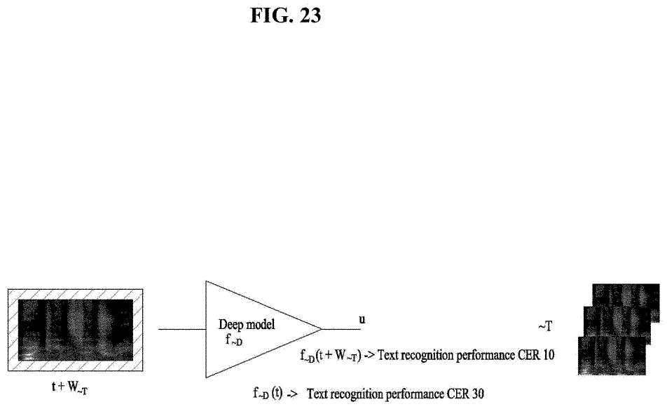

Referring to FIG. 23, the result u of recognizing speech recognition of high text recognition performance through a deep learning model using input data t+W˜_{T} in which a testing voice and a meta input are combined with each other is illustrated. A deep learning model f˜_{D} is a model trained with voice data D. Therefore, embodiments may obtain high speech recognition results with high performance using noisy input voice data together with a meta input in the user environment.

In other words, it is possible for embodiments to perform object detection and recognition in the image through FIGS. 12A to 23 described above. It is possible to perform object detection and recognition with high performance by using an object detection and recognition deep learning model learned in large amounts of data as a meta input suitable for the user environment. For example, it is possible for the user to detect a pedestrian and an abnormal object even in bad weather such as foggy days.

Furthermore, it is possible for embodiments to recognize an input audio. For example, when a speech recognizer synthesized with large amounts of data generates and uses a meta input suitable for the specific noisy environment of the user, it is possible to perform speech recognition in which performance is maintained.

Furthermore, it is possible for embodiments to recognize a video. It may be possible for embodiments to perform action recognition and video classification. For example, by recognizing an abnormal behavior in a security video and generating a meta input in the user environment regardless of weather or environment, high performance may be maintained while using the existing behavior recognition model.

Furthermore, embodiments are capable of performing text recognition and text conversion and may indicate high text recognition performance.

A commonly used deep learning model is learned for a long time with vast amounts of data. In many cases, the testing data environment is different from the training data environment upon user-centered inference. Therefore, when the pretrained model is used as it is in a situation where it is significantly changed upon user-centered inference, it is difficult to use the pretrained model because the performance is very low. Embodiments propose a method for generating and inferring a meta input in a user environment in which performance may be improved without re-training of a pretrained model upon user-centered inference. This is a new method that may be used even if the user in the user-centered inference step does not know trained data and a deep learning model structure, and separates a training model from a user inference environment upon user-centered inference. Embodiments show performance improvement with the inventive concept when the user environment is a noise environment. Therefore, the inventive concept may be utilized in a wide field where a training environment and a testing environment are different from each other.

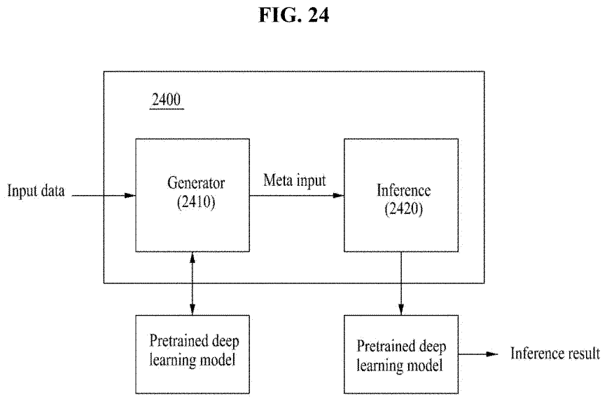

FIG. 24 is a drawing illustrating a configuration of a user-centered inference system via a meta input according to an embodiment, which illustrates a conceptual configuration of a server or system which performs the method of FIGS. 1 to 23.

Referring to FIG. 24, a user-centered inference system 2400 via a meta input according to an embodiment may include a generator 2410 and an inference unit 2420.

The generator 2410 may generate a meta input in the distribution of testing data in a user environment, when there is a pretrained deep learning model.

The generator 2410 may optimize training data ({x}∈D) and may generate a meta input W in the distribution T of testing data in a user-centered environment, when there is a pretrained deep learning model f˜_{D}. At this time, the generator 2410 may generate a meta input W˜_{T} through ground truth U of a sample T of the testing data in the user-centered environment. Thus, the generator 2410 may sample testing data (or input data) in the user environment and may generate the meta input using the pretrained deep learning model and the sampled testing data in the user environment.

In the generation process of embodiments, the loss function is minimized for the meta input W˜_{T} to optimize the meta input W˜_{T}.

The generator 2410 may achieve existing high performance upon interference, although the pretrained deep learning model is utilized as it is without re-training by adding the optimized meta input W*˜_{T} although any testing data is input within the testing data sample distribution T through the meta input W*˜_{T} generated in such an optimization scheme.

The inference unit 2420 may input an input, obtained by adding the generated meta input to the testing data in the user environment, to the pretrained deep learning model and may provide an inference result.

When the existing basic image classification model is a noise environment called T, in which the input data in the user environment is completely different from training data D, incorrect misclassification occurs due to data characteristics different from the trained data, resulting in a serious decrease in performance. Existing methods known to address such problems generate new training data including user data to re-train the deep learning model f. This has a fundamental problem in which the training time becomes long and re-training itself is difficult because there are many cases where users using actual edge-devices do not know the deep network structure and training data.

Instead, when the meta input generated by the generator 2410 is utilized, the pretrained deep learning model may be exploited immediately. The inference unit 2420 may add the optimized meta input W*˜_{T} to the testing data t′ in the user environment and may input an input, in which the testing data t′ in the user environment and the optimized meta input W*˜_{T} are combined with each other, to the pretrained deep learning model. Then, it is possible to use the pretrained deep learning model while maintaining performance in the distribution of new input data while using the parameters of the existing model as they are by giving the correct answer u′ of the input t′ even with the pretrained deep learning model.

Therefore, the user-centered inference system 2400 via the meta input according to embodiments achieves high inference performance even in testing data different from training data while using external signals as parameters of the pretrained deep learning model as they are. At this time, the external signal may play a role in helping the deep learning model receiving the new testing data to achieve the best performance.

It is apparent to those skilled in the art that, although the description is omitted in the system of FIG. 24, the respective means making up FIG. 24 may include all contents described in FIGS. 1 to 23. This is obvious to those skilled in the art.

As described above, embodiments may keep inference performance high with new testing data without re-training the pretrained deep learning model upon testing and may maintain performance when generating input data by adding the meta input to the test input content and inputting the input data to the pretrained deep learning model. Therefore, the meta input signal uses parameters of the pretrained model as they are, but may achieve high performance even on testing data different from training data. At this time, the meta input signal may play a role in helping the deep learning model receiving the new testing data to achieve the best performance.

The foregoing devices may be realized by hardware elements, software elements and/or combinations thereof. For example, the described systems, devices components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPGA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be embodied in any type of machine, components, physical equipment, virtual equipment, or computer storage media or devices so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The computer-readable media may also include, alone or in combination with the program instructions, data files, data structures, and the like. The program instructions recorded in the media may be designed and configured specially for the exemplary embodiments of the inventive concept or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

An embodiment promotes and activates new studies capable of exploiting the pretrained model in various user-centered environments by generating and inputting a meta input suitable for the user environment without the re-training of the model.

As an embodiment presents a new artificial intelligence utilization technique and system that solves the above problems to suit the user environment when exploiting the pretrained deep learning model upon inference (testing), even if it is testing in which data in an environment different from the training environment of the pretrained model is input, the user may achieve a high-performance effect.

An embodiment does not re-train the deep learning model with testing data, the environment of which is changed in order to adapt and utilize the user environment when inferring the deep learning model that requires large amounts of data and training for a long time and exploits the meta input suitable for the input data together with the input data from the user's point of view, thus utilizing the pretrained deep learning model to suit the user. Thus, the re-training of the model is not required, and the pretrained deep learning model may be exploited in various environments of the user upon inference.

Herein, the effects of the present embodiments are not limited to the effects and may be expanded in various manners from a range which does not deviate from the technical spirit and scope of the present embodiments.

While a few embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A meta input method for recycling of a pretrained deep learning model performed by a computer device, the meta input method comprising:
optimizing a meta input by considering a relation between input data and output prediction of the pretrained deep learning model; and
adding the optimized meta input to testing data in a user environment to transform distribution of the testing data into distribution of training data used to build the deep learning model.

2. The meta input method of claim 1, wherein the optimizing of the meta input includes:
optimizing the meta input using a gradient-based training algorithm through backpropagation.

3. The meta input method of claim 1, wherein the adding of the optimized meta input to the testing data includes:
shifting or aligning the distribution of the testing data in the user environment to suit the distribution of the training data by adding the optimized meta input to the testing data.

4. The meta input method of claim 1, wherein the adding of the optimized meta input to the testing data includes:
matching the distribution of the testing data in the user environment to the distribution of the training data through the optimized meta input, such that knowledge a pretrained black box deep neural network (DNN) already learned is able to be utilized even under an environment different from training.

5. The meta input method of claim 1, further comprising:
generating the meta input in the distribution of the testing data in the user environment, when there is the pretrained deep learning model, before optimizing the meta input.

6. The meta input method of claim 5, wherein the generating of the meta input includes:
generating the meta input through ground truth of a sample of the testing data in the user environment.

7. The meta input method of claim 6, wherein the generating of the meta input includes:
sampling the testing data in the user environment and generating the meta input using the deep learning model and the sampled testing data in the user environment.

8. The meta input method of claim 1, further comprising:
inputting and inferring an input, obtained by adding the optimized meta input to the testing data in the user environment, to the deep learning model.

9. A user-centered inference method via a meta input for recycling of a pretrained deep learning model performed by a computer device, the user-centered inference method comprising:
generating a meta input in distribution of testing data in a user environment, when there is the pretrained deep learning model; and
inputting and inferring an input obtained by adding the optimized meta input to the testing data in the user environment, to the deep learning model,
wherein the generating of the meta input includes:
optimizing the meta input by considering a relation between input data and output prediction of the pretrained deep learning model; and
adding the optimized meta input to the testing data in the user environment to transform the distribution of the testing data into distribution of training data used to build the deep learning model.

10. The user-centered inference method of claim 9, wherein the optimizing of the meta input includes:
optimizing the meta input using a gradient-based training algorithm through backpropagation.

11. The user-centered inference method of claim 9, wherein the adding of the optimized meta input to the testing data includes:
shifting or aligning the distribution of the testing data in the user environment to suit the distribution of the training data by adding the optimized meta input to the testing data.

12. The user-centered inference method of claim 9, wherein the adding of the optimized meta input to the testing data includes:
matching the distribution of the testing data in the user environment to the distribution of the training data through the optimized meta input, such that knowledge a pretrained black box deep neural network (DNN) already learned is able to be utilized even under an environment different from training.

13. A user-centered inference system via a meta input, the user-centered inference system comprising:
a generator configured to generate a meta input in distribution of testing data in a user environment, when there is a pretrained deep learning model; and
an inference unit configured to input and infer an input, obtained by adding the generated meta input to the testing data in the user environment, to the pretrained deep learning model.

14. The user-centered inference system of claim 13, wherein the generator generates the meta input through ground truth of a sample of the testing data in the user environment.

15. The user-centered inference system of claim 14, wherein the generator samples the testing data in the user environment and generates the meta input using the pretrained deep learning model and the sampled testing data in the user environment.

16. The user-centered inference system of claim 15, wherein the generator minimizes a loss function for the meta input to optimize the meta input, in generating the meta input.

17. The user-centered inference system of claim 16, wherein the inference unit adds the optimized meta input to the testing data in the user environment and inputs an input, in which the testing data in the user environment and the optimized meta input are combined with each other, to the pretrained deep learning model.

18. The user-centered inference system of claim 17, wherein the inference unit maintains performance in the distribution of the testing data in the user environment while using parameters of the pretrained deep learning model as they are.
